(19) United States
(12) Patent Application Publication
(10) Pub. No.: US 2022/0034743 A1
(43) Pub. Date: Feb. 3, 2022

(54) Leak Detector Film

(71) Applicant: 3M INNOVATIVE PROPERTIES COMPANY, St. Paul, MN (US)

(72) Inventor: Bharat R. Acharya, Woodbury, MN (US)

(21) Appl. No.: 17/281,375

(22) PCT Filed: Oct. 8, 2019
(86) PCT No.: PCT/IB2019/058575

§ 371 Date: Mar. 30, 2021

Related U.S. Application Data
(60) Provisional application No. 62/746,256, filed on Oct. 16, 2018.

(51) Int. Cl. G01M 3/16; G01M 3/18; G08B 21/20

(52) U.S. Cl. CPC G01M 3/165; G01M 3/18; G06F 1/20; G06F 2200/201; G08B 21/20

(57) ABSTRACT

A flexible leak detector film includes two spaced-apart, substantially coplanar elements, such that when the film is disposed adjacent a liquid-carrying conduit, and there is a leaked liquid released from the conduit, the film transmits at least a portion of the leaked liquid to an internal region of the film, thereby changing a characteristic of the elements which is detectable by detection circuitry coupled to the elements.

### BACKGROUND

Computer processing needs have grown exponentially in recent years, increasing the demand for faster, more powerful servers. Server manufacturers have responded to this growing need by creating servers with a greater number of more powerful processors, increasing the packing density of electronic components. The traditional air cooling process, where cold air is blown past the fins of heat sinks attached to electronic components to remove heat, is no longer adequate for these denser, more powerful servers. Companies have begun using direct contact liquid cooling (DCLC) heat exchangers, in which cold liquid is circulated through conduits over the cold plate attached to the processors and around components to remove heat away from the circuit. One concern with DCLC systems is that even a small leak of liquid can damage the electronic components in a server.

### SUMMARY

In some aspects of the present description, a film is described, including two spaced-apart, substantially coplanar elements, such that when the film is disposed adjacent a liquid-carrying conduit, and there is a leaked liquid released from the conduit, the film transmits at least a portion of the leaked liquid to an internal region of the film, the portion of the leaked liquid changing a characteristic of the elements detectable by a circuitry coupled to the elements.

In some aspects of the present description, a leak detection film is described, the film including a liquid-permeable substrate, a liquid-impermeable support substrate, and two spaced-apart substantially coplanar conducting films disposed between the liquid-permeable substrate and the support substrate. The liquid-permeable substrate, support substrate, and conducting films are substantially co-extensive in length. The leak detection film, when disposed adjacent a liquid carrying conduit, and in the presence of a leaked liquid released from the conduit, transmits at least a portion of the leaked liquid to an internal region of the leak detection film. The leaked liquid changes a characteristic of the conducting films which is detectable by circuitry coupled to the conducting films.

In some aspects of the present description, a liquid circulating system is described, comprising a liquid-carrying conduit, and a leak sensor extending along a length of the conduit. The leak sensor includes a liquid-permeable substrate facing and adjacent to the conduit, a support substrate, two spaced-apart substantially coplanar conductors disposed between the liquid-permeable substrate and the support substrate, and electrical circuitry coupled to the conductors for detecting a change in electrical properties between the conductors in a presence of a leaked liquid from the conduit.

### BRIEF DESCRIPTION OF THE DRAWINGS

FIG. 1 is an exploded diagram of a flexible leak detector film in accordance with an embodiment described herein;

FIG. 2A is a cross-sectional view of a flexible leak detector film in accordance with an embodiment described herein;

FIG. 2B is a cross-sectional view of a flexible leak detector film in accordance with an alternate embodiment described herein;

FIG. 2C is a cross-sectional view of a flexible leak detector film in accordance with an alternate embodiment described herein;

FIG. 3A is a perspective view of a flexible leak detector film wrapped helically around a liquid-carrying conduit in accordance with an embodiment described herein;

FIG. 3B is a cross-sectional side view of a flexible leak detector film wrapped helically around a liquid-carrying conduit in accordance with an embodiment described herein;

FIG. 4A is a cross-sectional view of a flexible leak detector film wrapped longitudinally around a liquid-carrying conduit in accordance with an embodiment described herein;

FIG. 4B is a cross-sectional view of a flexible leak detector film wrapped longitudinally around a liquid-carrying conduit in accordance with an alternate embodiment described herein;

FIG. 5 is a perspective view of a flexible leak detector film contained in an outer jacket in accordance with an embodiment described herein;

FIGS. 6A-6B are cross-sectional views of a flexible leak detector film contained in an outer jacket in accordance with embodiments described herein;

FIGS. 7A-7B present schematics of a circuit that may be used with a flexible leak detector film in accordance with an embodiment described herein;

FIG. 8 is a perspective view of a flexible leak detector film featuring an electrical connector in accordance with an embodiment described herein;

FIG. 9 provides a schematic of a circuit used for detecting a change in properties between two conductors of a flexible leak detector film in accordance with an embodiment described herein; and

FIG. 10 is a functional block diagram of electronic components which may be used to detect a change in properties between two conductors of a flexible leak detector film and trigger an appropriate response in accordance with an embodiment described herein.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

According to some aspects of the present description, a flexible film is described including two spaced-apart, substantially coplanar conducting elements. When the film is disposed adjacent to a liquid-carrying conduit, such as a coolant pipe in a liquid cooling system for an electronic system, and there is a leaked liquid released from the conduit, the film transmits at least a portion of the leaked liquid to an internal region of the film, where the leaked liquid changes an electrical characteristic of the conducting elements that is detectable by circuitry coupled to the conducting elements. In some embodiments, the conducting elements may be electrical conductors, including but not limited to conductive metal tapes, conductive wires, conductive traces, conductive contacts, or any other appropriate electrical conductor. In some embodiments, there may be more than two conducting elements, such as 3, 4, 5, 10, 20, or any appropriate number of conducting elements, and the leaked liquid may change an electrical characteristic between any two adjacent conducting elements, or any group of adjacent conducting elements. In some embodiments using multiple conducting elements, subsets of conducting elements may be connected together into two or more groups of conductors, the leaked liquid may change an electrical characteristic as measured between the two or more groups of conductors.

In some embodiments, the conducting elements may be electrical conductors, and the electrical characteristic may be an amount of resistance, an amount of capacitance, or any other appropriate characteristic exhibited among two or more of the conductors. The electrical conductors may be used as conductors attached to a leak detection circuit, which are connected to the leak detection circuit at one end of the film but unconnected and spaced apart at the other end of the film, the two substantially parallel conductors forming an open circuit. In some embodiments, the leaked liquid may be an electrically conducting liquid, such as water, a water/ethylene glycol mixture, or a liquid coolant, that forms a bridge between at least two adjacent conductors, effectively connecting the conducting elements and closing (i.e., shorting) the electrical circuit created by the conductors and the leak detection circuit (i.e., changing the resistance between them from an open circuit to the resistance of the conducting fluid connecting the conductors). In other embodiments, the leaked liquid may be a dielectric (i.e., electrically insulating) liquid, and the presence of the dielectric liquid between at least two adjacent conductors creates a change in the capacitance between the conductors.

In some embodiments, electrical circuitry (e.g., a leak detection circuit) may be attached to the conducting elements and may be used to detect the changing electrical characteristic of the conducting elements. In addition to detecting the changing electrical characteristic, the electrical circuitry may also initiate a response upon detecting the changing characteristic. For example, in some embodiments, the electrical circuitry may sound an alarm, display a visual indication to a user, energize a relay circuit to activate or deactivate controls attached to the relay circuit, terminate the flow of liquid (e.g., coolant) through the conduit, or turn on a back-up system, such as a fan.

In some embodiments, the flexible film itself may be used to contain the leaked liquid before it can reach other parts of the system in which the film is installed and cause damage, such as to an electronic component or external system. At least a portion of the film (e.g., an outer layer) may be liquid-impermeable, not allowing the leaked liquid to pass through the film. In some embodiments, the film may be wrapped helically around at least a portion of a liquid-carrying conduit (e.g., a coolant pipe), such that there are substantially no gaps between successive wraps of the film. This helical wrapping may create a barrier around the liquid-carrying conduit, effectively containing the leaked liquid. The film may have one or more extended edges including an adhesive layer, allowing successive wraps of the film to adhere to each other, creating the barrier. In some embodiments, the film may be wrapped longitudinally around at least a portion of a liquid-carrying conduit. In still other embodiments, the film may be applied to a surface of a liquid-carrying conduit, without being wrapped around the conduit. For example, a section of film may be placed over a joint or a seam between two plates in a cooling system, or on the surface of a cold plate, effectively sealing the seam and simultaneously allowing the detection of leaked liquids therethrough.

According to some aspects of the present description, a flexible leak detection film is described, the film including a liquid-permeable substrate, a liquid-impermeable support substrate, and two spaced-apart, substantially coplanar conducting films disposed between the liquid-permeable substrate and the support substrate. The liquid-permeable substrate, support substrate, and conducting films are substantially co-extensive in length. The leak detection film, when disposed adjacent a liquid carrying conduit, such as a pipe containing liquid coolant, and in the presence of a leaked liquid (e.g., coolant) released from the conduit, transmits at least a portion of the leaked liquid to an internal region of the leak detection film. The leaked liquid changes a characteristic of the conducting films which is detectable by circuitry coupled to the conducting films.

The conducting films may be any appropriate electrically conductive tapes and/or films. The leak detection film may further include an adhesive layer. In some embodiments, the adhesive layer is disposed between the support substrate and the conducting films, such that the adhesive layer causes the conductive films and/or liquid-permeable substrate to adhere to the support substrate. In some embodiments, the conducting films may themselves have an adhesive layer. For example, the conducting films may be a conductive copper tape, where one side of the copper tape has an adhesive. In some embodiments, the conducting films may be formed by directly depositing an electrically conductive material such as copper by a deposition process such as sputter coating or vacuum deposition. In such cases, a thin adhesion layer such as a layer of titanium may be deposited prior to the deposition of the conducting layer. In some embodiments, the conducting films may be deposited by masking a portion of the support substrate to create the parallel conducting elements. In some embodiments, the parallel conducting elements are formed by selectively removing a portion of the conducting film from a uniformly coated film using film removal processes such as photolithography.

In some embodiments, the adhesive layer may be a separate layer disposed on the support substrate. The support substrate and the adhesive layer may each have at least one longitudinal edge extending beyond the liquid-permeable substrate, such that the leak detection film may adhere to itself when helically or longitudinally wrapped around a liquid-carrying conduit, such as a coolant pipe, or may adhere to a surface, such as the face of a cooling system, creating a seal between the support substrate and the face of the cooling system.

In some embodiments, the flexible leak detection film may include a connector attached to an end of each of the conducting films. The connector may be separate from the leak detection film, and may provide a means of attaching each of the conducting films to an appropriate termination point in an attached electrical circuit, such as a leak detection circuit.

According to some aspects of the present description, a liquid circulating system is described, comprising a liquid-carrying conduit, and a flexible leak sensor extending along a length of the conduit. The leak sensor includes a liquid-permeable substrate (e.g., a porous material) facing and adjacent to the conduit, a support substrate, two spaced-apart substantially coplanar conductors disposed between the liquid-permeable substrate and the support substrate, and electrical circuitry coupled to the conductors for detecting a change in electrical properties between the conductors in a presence of a leaked liquid from the conduit. In some embodiments, the leaked liquid may be an electrically conductive liquid (i.e., a conducting liquid) and the change in electrical properties detected by the circuitry may be a change in resistance between the conductors. In some embodiments, the leaked liquid may be a dielectric liquid (i.e., an electrically-insulating liquid) and the change in electrical properties detected by the circuitry may be a change in capacitance between the conductors.

In some embodiments, the leak sensor may be wrapped around a portion of the liquid-containing conduit such that the support substrate forms an outer barrier substantially containing the leaked liquid. Wrapping the leak sensor around the liquid-containing conduit also serves to maximize the amount of surface area of the substantially coplanar conductors that is adjacent to the liquid-carrying conduit.

For the purposes of this specification, the term “conduit” shall be defined to mean any channel or enclosed passageway through which a liquid may pass. A conduit may be any appropriate shape, including but not limited to a box, prism, cylinder, sphere, trench, or pipe, and may be of any appropriate dimensions. Examples of conduits used throughout this specification include conduits carrying liquid coolant through an electronic system. However, these examples are not meant to be limiting. A conduit as used herein may be any appropriate enclosed passageway through which liquid may flow. For example, a conduit may be a pipe carrying water to a kitchen sink, or a cold plate attached to the central processing unit of a server.

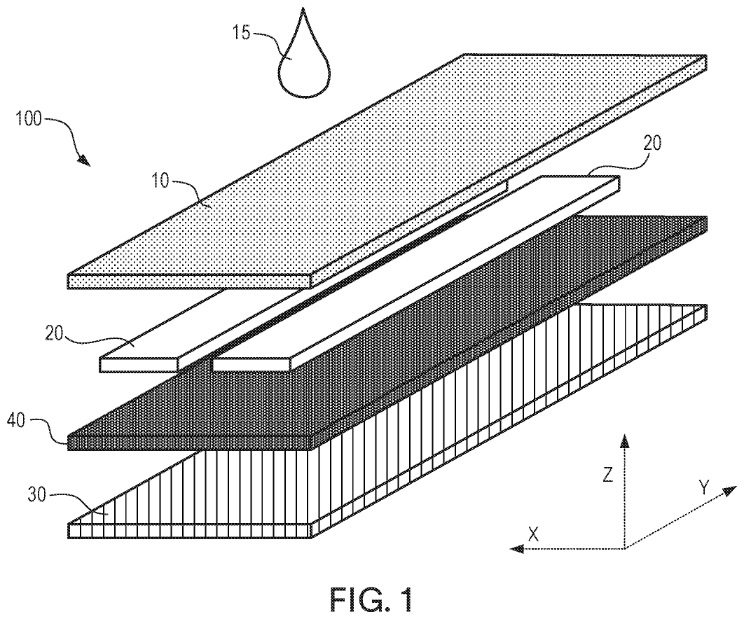

Turning to the figures, FIG. 1 is an exploded diagram of a flexible leak detector film 100 in accordance with an embodiment described herein. In some embodiments, the leak detector film 100 is a stack of films including a liquid-permeable substrate 10, two substantially coplanar conductors 20, and a support substrate 30. In some embodiments, the leak detector film 100 also includes an adhesive layer 40, disposed between the support substrate 30 on one side and the conductors 20 and liquid-permeable substrate 10 on the other side, as shown in FIG. 1. When assembled, the leak detector film 100 will allow a liquid 15 to be transmitted through the liquid-permeable substrate 10, where it comes into contact with, and bridges the gap between, conductors 20. When the conductors 20 are connected to a leak detection circuit (discussed in later figures), and liquid 15 comes between spaced-apart conductors 20, the liquid causes an electrical characteristic (as measured by the leak detection circuit) of the conductors 20 to change.

In some embodiments, liquid 15 is an electrically conductive liquid (e.g., water), and the liquid can form a bridge between the conductors (i.e., short circuit), changing the resistance between the conductors from an open circuit (effectively infinite resistance) to the resistance of the liquid 15 the gap between conductors 20. In some embodiments, liquid 15 is a dielectric liquid (i.e., an electrically insulating liquid). When a dielectric liquid is between conductors 20, no electrical current can flow between the conductors 20, but the amount of capacitance between conductors 20 will change (e.g., the capacitance will increase when the dielectric is present).

The liquid-permeable substrate 10 may be any porous, non-conducting material that allows the transmission of an appropriate liquid (such as a liquid coolant) therethrough. In some embodiments, the liquid-permeable substrate 10 may be a woven or nonwoven material, made from flexible polymeric or nonpolymeric fibers. In some embodiments, the liquid-permeable substrate 10 may be a polypropylene nonwoven mesh. In some embodiments, an appropriate nonwoven mesh may be created using a drilled orifice die. Meltblown fibers may be created by distributing a molten polymer across the drilled orifice die such that the polymer exits the die through a series of orifices to create filaments. A heated air stream may be used to carry the filaments exiting the die to a moving belt where they are collected to form a web. The temperature and velocity of the air stream to achieve the desired fiber diameter. This method of creating a liquid-permeable substrate 10 is for illustration purposes only, and is not meant to be limiting. Any appropriate liquid-permeable substrate 10 may be used. In some embodiments, the liquid-permeable substrate 10 is used as an electrically insulating layer over the top of the conductors 20.

In some embodiments, the conductors 20 are electrically conducting films, such as a copper foil shielding tape or similar conducting film. The use of conducting films for conductors 20 allows leak detector film 100 to maintain a minimal thickness (i.e., Z dimension in FIG. 1), as well as be flexible such that it can be wrapped around coolant conduits with relatively little clearance required. In some embodiments, conductors 20 are coplanar. That is, both conductors are disposed side-by-side within the same plane, extending substantially the length of the leak detector film 100, spaced apart and substantially parallel. Conductors 20 may be any appropriate electrically conducting material, including, but not limited to, copper, copper-covered steel, copper alloys (e.g., cadmium-chromium copper, cadmium copper, chromium copper, zirconium copper, etc.), stainless steel, gold-plated stainless steel, iron, nickel, tin, zinc, silver, gold, aluminum, brass, carbon, carbon allotropes (e.g., graphite, carbon nanotubes, graphene, carbon composites), and conducting polymers (e.g., polyacetylene, polyphenylene vinylene, polypyrrole, polythiophene, polyaniline, polyphenylene sulfide). In some embodiments, the conductors 20 may be conductive films deposited directly onto the support substrate 30 without requiring additional adhesive to adhere the conductors 20 to the substrate 30. For example, the conductors 20 may be deposited on the support substrate 30 through a sputter coating process.

In some embodiments, the adhesive layer 40 may be disposed on the support substrate 30, such that it allows conductors 20 and portions of liquid-permeable substrate 10 to adhere to the support substrate 30. In some embodiments, the adhesive layer 40 may be a separate layer added during manufacturing of leak detector film 100. In some embodiments, the adhesive layer 40 may be integral to support substrate 30. In some embodiments, the adhesive layer 40 may be integral to both the conductors 20 (e.g., conductive tape with adhesive side) and/or the liquid-permeable substrate 10. The adhesive layer 40 may be any appropriate adhesive, including, but not limited to, acrylates, epoxies, polyurethanes, and polyimides.

In some embodiments, the support substrate 30 may be substantially the same width (i.e., X-dimension in FIG. 1) of the liquid-permeable substrate 10. In some embodiments, the support substrate 30 may be wider than the liquid-permeable substrate 10 on at least one longitudinal edge. A support substrate 30 with at least one longitudinal edge that extends beyond the corresponding longitudinal edge of the liquid-permeable substrate 10 may allow the leak detector film 100 to be wrapped helically around a liquid-carrying conduit such that each successive wrap of the film 100 around the conduit overlaps the previous wrap of the film 100, such that there are no gaps between successive wraps of the film 100. In some embodiments, the extended edge of support substrate 30 may also allow a first longitudinal edge of the support substrate 30 to overlap or otherwise attach to a second longitudinal edge of the support substrate 30, when the leak detector film 100 is longitudinally wrapped around a conduit.

In some embodiments, when at least one longitudinal edge of support substrate 30 is extended beyond the width of the liquid-permeable substrate 10, the adhesive layer 40 is sized to match the width of the support substrate 30. That is, the adhesive layer 40 may be used to adhere a first longitudinal edge of the support substrate 30 to a second longitudinal edge of an adjacent wrap of the support substrate 30 in a helical wrapping, or to adhere first and second longitudinal edges of the support substrate 30 to each other in a longitudinal wrapping. Additional detail on the adhesive layer 40 and wrapping options will be discussed in additional detail in the remaining figures.

It should be noted that the position, size, and order in the stack of adhesive layer 40 may vary beyond what is shown in the figures or discussed in the corresponding sections of the specification. In some embodiments, one or more of the layers may itself have one or more adhesive elements. For example, the conductors 20 may be in the form of a double-sided electrically-conductive adhesive tape and the adhesive surfaces of the conducting adhesive tape will adhere to the support substrate 30 on one side and the liquid-permeable substrate 10 on the opposite side. In some embodiments, the adhesive layer may be deposited onto the support substrate 30, the liquid-permeable substrate 10, and/or the conductors 20 in strips or small sections as required to hold the conductors 20 in place and to adhere the liquid-permeable substrate 10 to the support substrate 30. In some embodiments, the leak detector film 100 may be held together using mechanical features or through a mechanical compression against a liquid-carrying conduit, and may not require an adhesive layer at all.

In some embodiments, the support substrate 30 is a liquid-impermeable material (i.e., it will not allow liquid to transmit therethrough). In some embodiments, a liquid-impermeable support substrate 30 has the added functionality of containing a liquid that has leaked out of a liquid-carrying conduit. In this way, the leak detector film may be used to both detect a leaked liquid and contain the leaked liquid until a mitigating action can be taken.

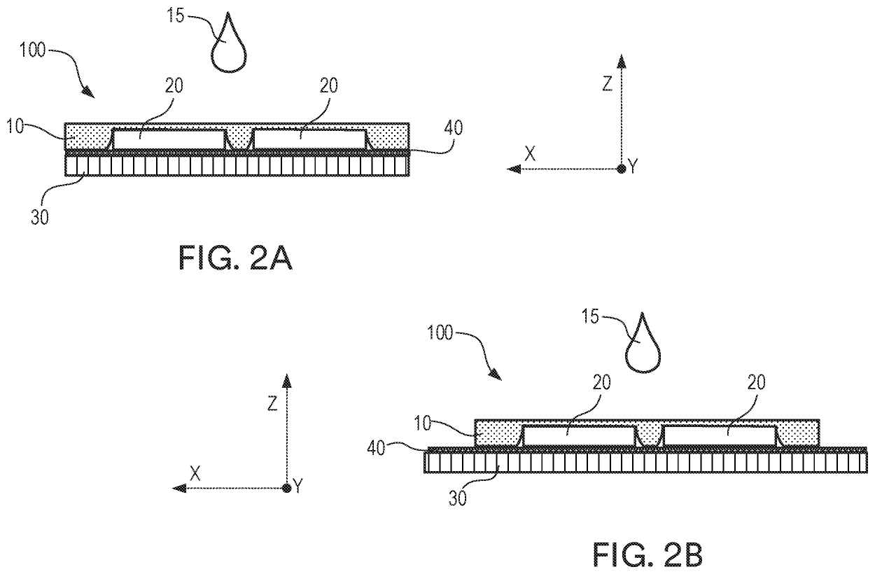

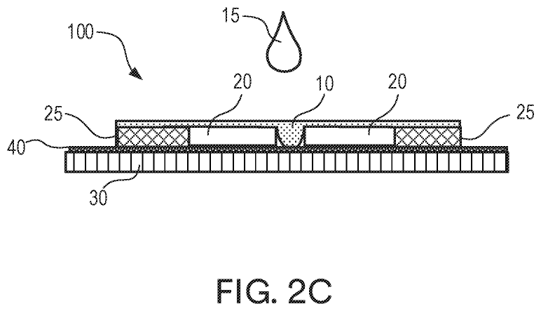

FIGS. 2A-2C are cross-sectional end views of alternate embodiments of the leak detector film of FIG. 1 in accordance with an embodiment described herein. Leak detector film 100 includes a support substrate 30, an adhesive layer 40, two or more conductors 20, and a liquid-permeable substrate 10. The leak detector film 100 may be placed on or around a liquid-carrying conduit or other potential source of leaked liquids such that the side of leak detector film 100 having the liquid-permeable substrate 10 is facing the potential source of leaked liquid 15. Conductors 20 may be conducting films or any appropriate conductors, are disposed on adhesive layer 40, which holds them in place and keeps them spaced apart and substantially parallel along the length (i.e., along the Y dimension in FIG. 2A, extending into the page) of leak detector film 100. In some embodiments, liquid-permeable substrate 10 is sized to be wider (i.e., in the X dimension in FIGS. 2A/2B) than the combined width of conductors 20 plus the gap between them, such that conductors 20 are substantially surrounded by liquid-permeable substrate 10 on three sides and adhesive layer 40 and support substrate 30 on the fourth side.

In the embodiment shown in FIG. 2A, support substrate 30 and adhesive layer 40 are substantially the same width as liquid-permeable substrate 10. However, in the embodiment shown in FIG. 2B, support substrate 30 and adhesive layer 40 are wider than liquid-permeable layer 10, allowing layers 30 and 40 to extend past the liquid-permeable layer 10 on at least one longitudinal edge (or both longitudinal edges, as shown in FIG. 2B). In some embodiments, this overhang of the support substrate 30 and adhesive layer 40 may be useful in allowing leak detector film 100 to be sealed against itself when wrapped around a liquid-carrying conduit, or otherwise sealed against an external surface of a liquid-carrying conduit. Additional detail on the application of leak detector film 100 to a liquid-carrying conduit is provided in the remaining figures.

FIG. 2C is a cross-sectional view of an alternate flexible leak detector film 100, in which liquid-absorbing material 25 is added to help contained leaked liquid. The elements of FIG. 2C which share reference designators with like elements of FIG. 2B represent the same components, each having the same function. However, in the embodiment of FIG. 2C, liquid-absorbing material 25 has been added, disposed between the liquid-permeable substrate 10 and adhesive layer 40, and extending along the outer longitudinal edges of, and substantially coplanar with, conductors 20. It should be noted that, in this embodiment, liquid-absorbing material 25 is not placed in the gap between adjacent conductors 20, as the presence of liquid-absorbing material 25 could reduce the sensitivity of the leak detector film 100. However, alternate placements and configurations of the liquid-absorbing material 25 are possible without deviating from the concepts described herein, and an embodiment having liquid-absorbing material 25 in at least a portion of the gap between conductors 20 is within the scope of the disclosure.

The liquid-absorbing material 25 used in the leak detector film 100 may include, but not be limited to, sodium polyacrylate, anhydrous calcium chloride, soda lime, allochroic silica gel, and plaster-of-Paris, or any appropriate material capable of absorbing liquid.

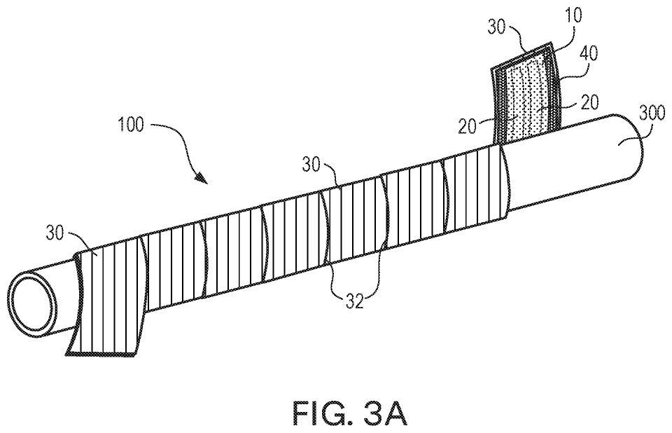

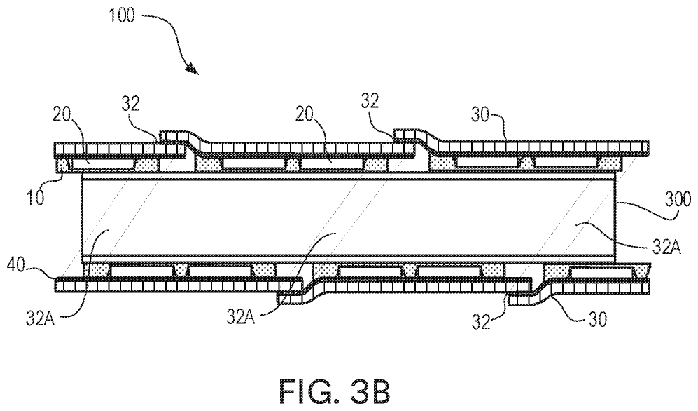

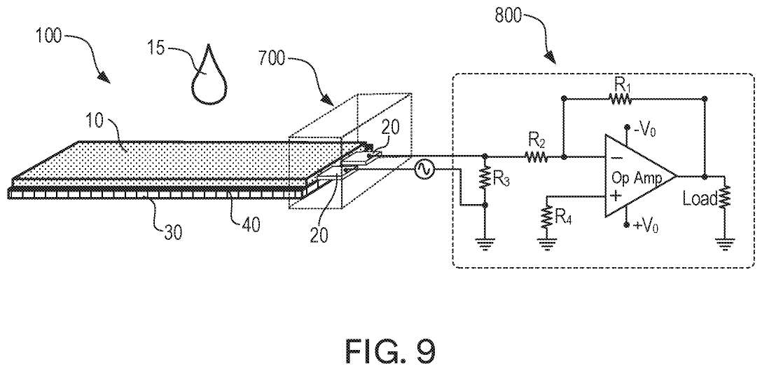

FIG. 3A is a perspective view of a leak detector film 100 wrapped helically around a liquid-carrying conduit 300 in accordance with an embodiment described herein. In some embodiments, the leak detector film 100 may be wrapped helically around a liquid-carrying conduit 300 (e.g., a liquid coolant pipe in a cooling system) such that the liquid-permeable substrate is facing and adjacent to the surface of conduit 300. As previously described, a leaked liquid (e.g., liquid coolant, not shown) that leaks from the interior of conduit 300 will first enter the liquid-permeable substrate 10, where it is transmitted through to conductors 20. The leaked liquid will spread on and between conductors 20, creating a bridge therebetween. The presence of the liquid between or among conductors 20 will change an electrical characteristic of the conductors 20 (e.g., an amount of resistance or capacitance), as measured by circuitry attached to conductors 20 (not shown, see FIG. 9).

In some embodiments, an adhesive layer 40 is disposed on a support substrate 30, such that the conductors 20 and liquid-permeable substrate 10 are held in place against the support substrate 30. In addition to holding conductors 20 and liquid-permeable substrate 10 in place, the adhesive layer may provide an additional function, such as adhering successive wraps of the leak detector film 100 to each other, and/or adhering the leak detector film 100 to the conduit 300.

In some embodiments, support substrate 30 is constructed of a non-conducting material that is impermeable to liquids (i.e., will not transmit liquids therethrough), which may include, but is not limited to, polyolefins, polyimides, polyethylene terephthalates, polyesters, polyvinyl, fluoropolymers, silicones, natural rubbers, synthetic rubbers, nylon, polyurethanes, and acrylates. This allows the support substrate 30 to function as an outer layer which can contain a liquid that has leaked out of the conduit 300. Containing the liquid not only prevents the liquid from spilling out into the surrounding area (e.g., into sensitive electronic components), but also helps concentrate the liquid around the conductors 20 (also “contained” within the support substrate), aiding in earlier detection of leaks.

In some embodiments, the leak detection film 100 may be wrapped around conduit 300 such that each successive wrap of the film 100 abuts or overlaps the previous wrap, creating sealed seams 32 in the support substrate 30. By eliminating potential gaps at the locations of the seams 32, leaked liquid will be effectively contained within the leak detector film 100, until a mitigating action can be initiated (e.g., stopping the flow of coolant through conduit 300).

FIG. 3B is a cross-sectional side view of the leak detector film 100 of FIG. 3A. FIG. 3B illustrates how each successive wrap of the helically-wrapped leak detector film 100 may overlap the previous wrap to create sealed seams 32 and overlapped edges 32A (shown here as dashed lines). By overlapping each wrap slightly, support substrate 30 forms an outer barrier layer for the leak detector film 100, effectively containing any potential spills of liquid from conduit 300. FIG. 3B also illustrates how a helical wrapping of leak detector film 100 may cause the conductors 20 to surround the conduit 300 on all sides. This allows the leak detector film 100 to detect leaks more quickly (by covering more surface area on conduit 300), as well as help contain the leak within the leak detector film 300.

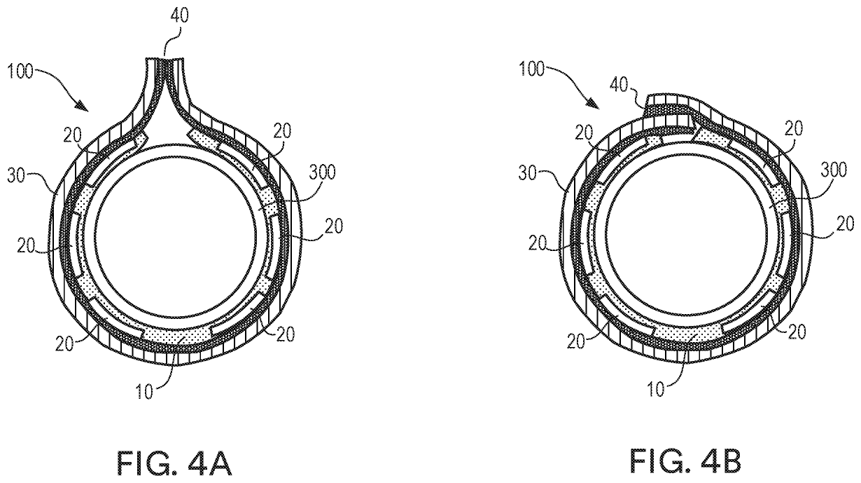

FIGS. 4A and 4B are cross-sectional, end views of a flexible leak detector film 100 wrapped longitudinally around a liquid-carrying conduit in accordance with an embodiment described herein. In the embodiments shown in FIGS. 4A and 4B, the leak detector film 100 extends along the section of conduit 300 to be covered (extending into the page in the figures) and is wrapped along its longitudinal axis to encircle the conduit 300. In some embodiments, multiple conductors 20 (e.g., 6 conductors, as shown in FIGS. 4A and 4B) may be used to ensure adequate areas of detection around the circumference of conduit 300. In other embodiments, a single pair of conductors 20 may be used, ideally positioned within the support substrate 30 such that the gap between the conductors 20 is at the point where the leaked liquid will collect (e.g., at the bottom, underneath the conduit 300, relative to the Earth, where gravity will pull the liquid). If only two conductors 20 (or a small number) are used, the width of the liquid-permeable substrate 10 can be reduced from that shown in the examples of FIGS. 4A and 4B, such that only conductors 20 present and the area immediately surrounding those conductors 20 are covered by the liquid-permeable substrate 10.

In the embodiment of FIG. 4A, the support substrate 30 and adhesive layer 40 are sized to extend beyond the longitudinal edges of liquid-permeable substrate 10, allowing the extended edges to be pressed together to contain the conduit 300. In the embodiment of FIG. 4B, the edges of support substrate 30 and adhesive layer 40 are similarly extended, but the seal is created by overlapping one edge over the other.

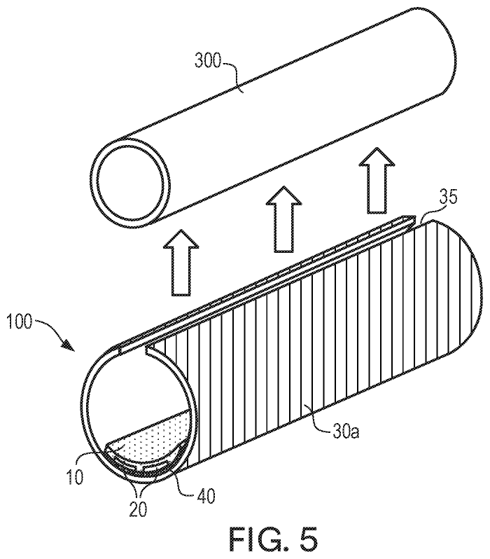

FIG. 5 is a perspective view of a flexible leak detector film 100 in which the support substrate 30a is in the form of an outer jacket in accordance with an embodiment described herein. In some embodiments, the support substrate 30a may be a separate component from leak detector film 100. That is, leak detector film 100 may include a liquid-permeable substrate 10 surrounding two or more conductors 20, and, optionally, adhesive layer 40. In some embodiments, adhesive layer 40 may be separate from leak detector film 100, as well, either as a separate component or omitted entirely. The support substrate 30a may be formed as a cylindrical jacket, into which the leak detector film is disposed in a manufacturing step. In some embodiments, support substrate 30a may have cut 35, which may be used for installing the support substrate 30a around conduit 300. In some embodiments, support substrate 30a may not have cut 35, and may be placed around conduit 300 during an installation or manufacture of conduit 300. In some embodiments, the outer jacket may serve as a conduit to transfer leaked liquid from one point (e.g. leak sensitive area of the server) to another point (e.g. outside the server).

In some embodiments, leak detector film 100 may be “installed” on the inside surface of support substrate 30a. As previously described, leak detector film 100 may include an adhesive layer 40 which may be applied to the inner surface of support substrate 30a. In other embodiments, adhesive layer 40 may be a separate component which is placed between the inner surface of support substrate 30a and leak detector film 100. The leak detector film 100 may be positioned inside support substrate 30a such that it is at a “low point” (i.e., placed at the point where gravity would cause a liquid leaking from conduit 300 to collect).

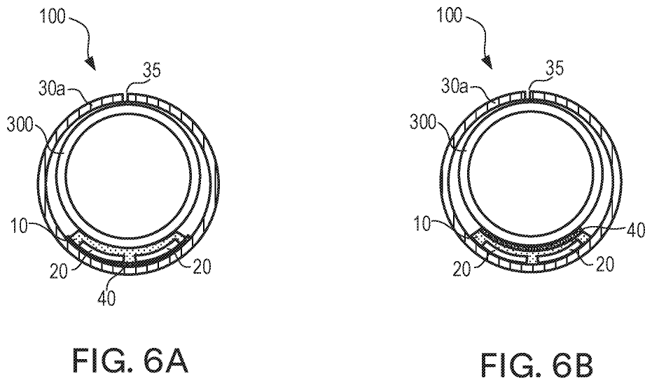

FIGS. 6A-6B are cross-sectional, end views of the leak detector film 100 of FIG. 5, showing the support substrate 30a as it would appear installed on conduit 300. In the embodiment of FIG. 6A, leak detector film 100 includes liquid-permeable substrate 10 disposed over and around conductors 20. An adhesive layer 40 is disposed between the combined layers of liquid-permeable substrate 10 and conductors 20 and the inner surface of the cylindrical “jacket” of support substrate 30a. In the embodiments of FIG. 6B, the adhesive layer 40 is disposed on the bottom surface of conduit 300 and no adhesive is placed between the conductors 20 and support substrate 30a. In this configuration, adhesive layer 40 may be patterned to contain gaps or cuts that allow liquid leaking from the conduit to pass into liquid-permeable substrate 10 and conductors 20. Support substrate 30a may be held in place by its cylindrical walls wrapping around conduit 300. In some embodiments, no adhesive layer 40 may be used, and the conductors 20 and liquid-permeable substrate 10 may be held in place by mechanical pressure from support substrate 30a when installed on conduit 300.

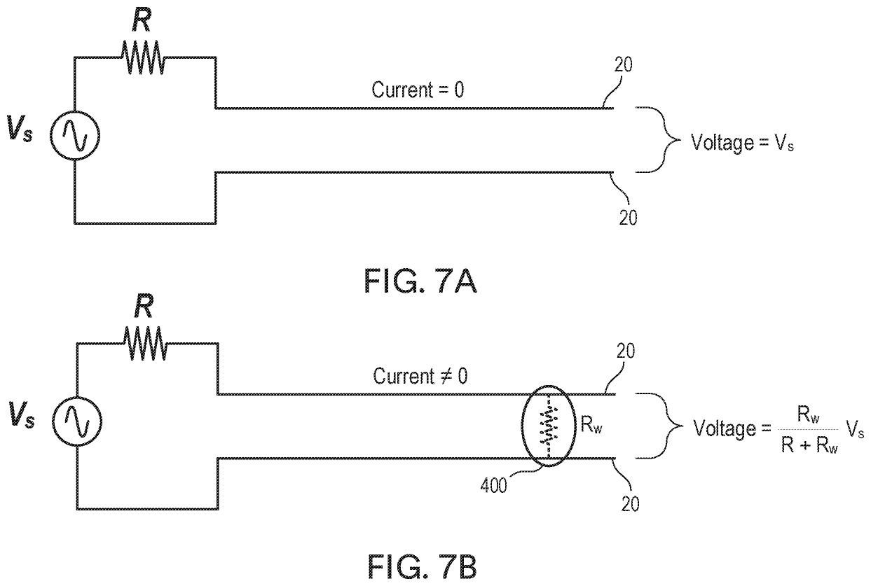

FIGS. 7A-7B present schematics of a simple electrical circuit that may be used with a flexible leak detector film in accordance with an embodiment described herein. Conductors 20 are the conductors from the leak detector film 100 of any of the previous figures. As shown in FIG. 7A, when the gap between conductors 20 is filled with an insulating material (e.g. air, polymer, a dielectric) the circuit behaves as an open circuit. That is, the external potential difference maintained between the two conductors 20 cannot induce current flowing across conductors 20. Since there is no current flowing through the circuit, the voltage drop across conductors 20 is the same as the source voltage, Vₛ.

When a conductive fluid (e.g., a leaked liquid from a coolant conduit) comes into contact with and bridges the gap between conductors 20, the conductive fluid closes the electrical circuit, enabling the flow of electrical current through the circuit. As a result of finite current flowing through the circuit, the total voltage drop across conductors 20 is lower than the source voltage, Vₛ, and is determined by the relative magnitudes of the external resistance (R) and the resistance (R_{w}) of the conductive fluid, as shown in FIG. 7B. If the resistance per unit length of conductors 20 is known, the location of leak along the length of the conductors 20 can also be determined based on the detected change in signal.

As previously described herein, the liquid leaked from a liquid-carrying conduit may be electrically insulating (i.e., a dielectric) rather than an electrically conductive fluid. In this embodiment, the capacitance between the separated conductors 20 increases in the presence of a dielectric fluid between conductors 20, relative to the capacitance seen without the fluid present.

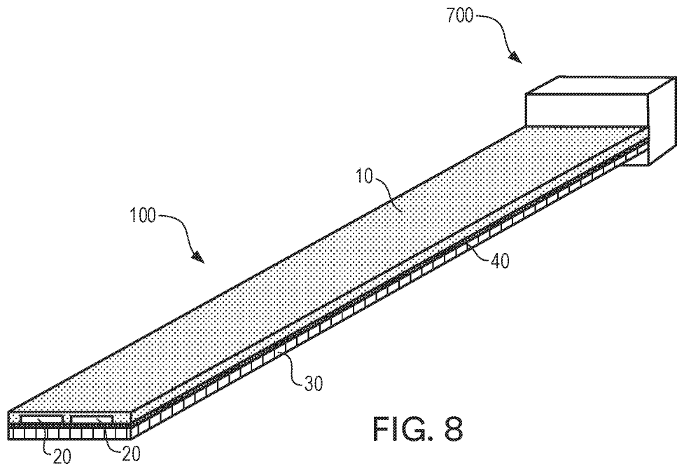

In some embodiments, flexible leak detector film 100 may include a connector connected to conductors 20. FIG. 8 is a perspective view of leak detector film 100 featuring an electrical connector 700 in accordance with an embodiment described herein. FIG. 9 provides a cutaway view of connector 700, illustrating how conductors 20 are connected to an external circuit used for detecting a change in properties between the conductors.

FIG. 9 includes a simple schematic of one embodiment of an electrical circuit 800 which may be used to detect a change between conductors 20 (e.g., a change in resistance between conductors 20 in the presence of leaked liquid 15) and, in some embodiments, to initiate a mitigating action. R1 is a variable resistance which may be used to adjust the gain of the operational amplifier (op amp). R2, R3, and R4 are resistance values which may be selected based on the requirements of the application. The output of the operational amplifier (op amp) can be used to drive the load. The load may be any appropriate load, including but not limited to an alarm, indicator light, pump, electrical relay, or cooling fan.

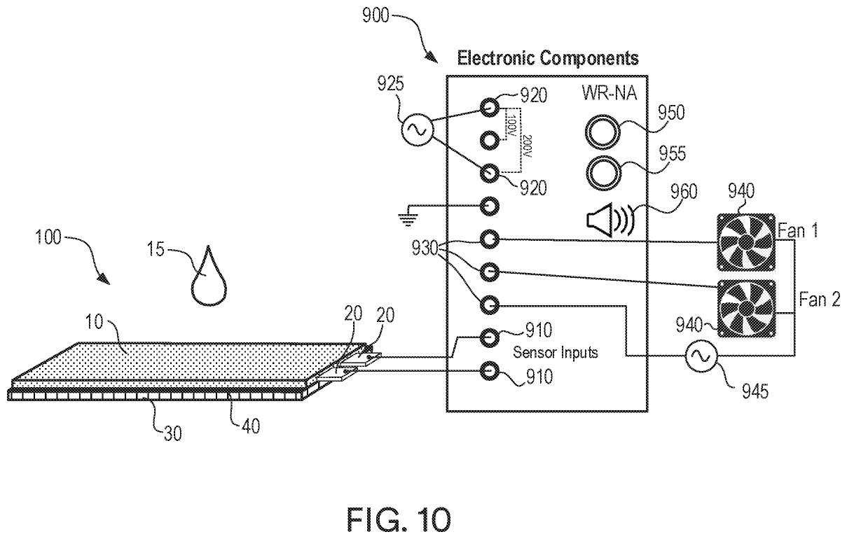

Finally, FIG. 10 is a functional block diagram of electronic components 900 which may be used to trigger an appropriate response to the detection of a leaked liquid 15. In a scenario, leaked liquid 15 enters liquid-permeable substrate 10, which transmits liquid 15 therethrough to conductors 20. Conductors 20 are coplanar and substantially parallel, held spaced apart for the length of leak detector film 100 by adhesive layer 40, which is disposed on support substrate 30. When the liquid 15 bridges conductors 20, circuitry in electronic components 900 (e.g., the schematic of FIG. 9) detects a change in an electrical characteristic between conductors 20 through sensor inputs 910. As a result of detection of leaked liquid 15, electronic components 900 may initiate a mitigating action in response. For example, as shown in the simple schematic of FIG. 9, the electronic components 900 may drive a load, which may include, but is not limited to, an power indicator light 950, a leak detector indicator light 955, an audible alarm 960, and/or cooling fans 940. In some embodiments, electronic components 900 may be supplied by an external power source 925, and may control power sources 945 for fans 940 or other appropriate loads.

### EXAMPLES

A flexible leak sensor film was fabricated by laminating a water-permeable electrically insulating substrate, two in-plane, parallel conducting elements, and a water-impermeable support substrate using adhesives. An electrical circuit was built to demonstrate the performance of the sensor. These examples are merely for illustrative purposes only and are not meant to be limiting on the scope of the appended claims.

The following abbreviations are used herein: cm=centimeters; mm=millimeters; kΩ=kilo Ohms; V=volts; s=seconds; ml=milliliters; gsm=grams per square meter; lb/hr=pounds per hour; kg/hr kilogram per hour; ft/min=feet per minute; m/min=meter per minute; AC=alternating current; DC=direct current.

Materials Table:

| Abbreviation | Description |
|---|---|
| R₁ | Nominally 47 kΩ Resistance available from Panasonic Electronics |
| | Corporation, Japan; available as “ERO-S2PHF 4702” |
| C | Conductive copper tape with adhesive available from 3M Corporation, |
| | St Paul, MN; available as “3M EMI Copper Foil Shielding Tape1181- |
| | HD” |
| S | Water impermeable support substrate with adhesive available 3M |
| | Corporation, St Paul, MN; as “3M Crepe Masking Tape 202” |
| I | Water permeable electrically insulating nonwoven web (details |
| | described below) with 10 grams per square meter basis weight. |
| PP | Polypropylene polymer available from LyondellBasell, Rotterdam, |
| | Netherlands, and commercially available through Nexeo Solutions, |
| | The Woodlands, TX; available as “MF-650X”. |
| DMM | Digital Multimeter, available from Fluke Corporation, Everette, WA; |
| | as “RMS Multimeter Model 115” |
| LDC | A leak detector cable supplied from RLE Technologies Fort Collins, |
| | CO; available as “Leak Detector Cable SC-B” |

Equipment Table:

| Name | Description |
|---|---|
| Oscilloscope | A digital oscilloscope available from Tektronix Inc, Beaverton, OR; |
| | available as “Oscilloscope TDS 2024B” |
| Waveform | A signal generator to generate different signals available from, Keithley |
| Generator | Instruments Co, Cleveland, OH; as “Waveform Generator Model 3390” |
| Power | A regulated DC power supply supplied from BK Precision Corporation, |
| Supply | Yorba Linda, CA, available as “Power Supply Model #1671A” |
| Leak | An electronic device that provides audio visual signal in response to |
| Detector | change in resistance between two conductors and provides relay |
| Device | switches that turn ON and OFF depending on the resistance between two |
| | Sensor Terminals supplied from 3M Japan; available as “3M WR-NA |
| | Leak Detector” |
| Server | Two server cooling fans supplied from Raising Electronics, Sacramento |
| Cooling Fan | CA; available as “Fan 110V Rack Mount 2 Pieces (ASIN |
| | B06Y3PF58G)” |

### Example 1

A flexible leak detector film was constructed by slitting a 50.8 cm long 0.635 cm wide conducting element C in two halves along the length. Two approximately 0.3175 cm wide halves of the conducting elements C were then hand laminated on to water impermeable support substrate S with the adhesive sides of the substrate and conductive elements facing each other. The spacing between two edges of the conductive elements was about 1 mm. A layer of highly porous water-permeable electrically insulating polypropylene nonwoven web I prepared as described below, was overlaid and attached to exposed adhesive of the support substrate S.

A polypropylene non-woven web was used as a water-permeable insulator layer on top of the conducting elements. The non-woven web was formed using a drilled orifice die. Melt blown fibers were created by a molten polymer entering the die, the flow being distributed across the width of the die in the die cavity and the polymer exiting the die through a series of orifices as filaments. A heated air stream passed through air manifolds and an air knife assembly adjacent to the series of polymer orifices that carried out the filaments coming from the die exit (tip). This heated air stream was adjusted for both temperature and velocity to attenuate (draw) the polymer filaments down to the desired fiber diameter. The meltblown fibers were conveyed in this turbulent air stream towards a moving belt where they collect to form a web.

A roll of approximately 20 inch (50.8 cm) wide non-woven web was collected under the conditions as follows: The PP was extruded through a 20 inch (50.8 cm) wide drilled orifice die at 49 lb/hr (22.2 kg/hr). The polymer melt temperature was 435.2 degrees F. (224 degrees C.). The die-to-collector distance was 7.5 inches (19.05 cm). Samples of the web were collected on a stainless steel moving belt at 129 ft/min (39.3 m/min), the melt:blown web was separated from the belt and evaluated for effective fiber diameter (EFD) according to the method set forth in Davies, C. N., “The Separation of Airborne Dust and Particles,” Institution of Mechanical Engineers, London Proceedings IB 1952. The air temperature and velocity were adjusted to achieve an effective fiber diameter of 30 micrometers, The basis weight of the web was calculated by die cutting 5.25-inch (13.33 cm) diameter discs and taking their weight in grams. The basis weight of the non-woven web was calculated by dividing the mass of the disc by its area and calculated to be 20 gsm.

### Comparative Example 1

Comparative Example 1 was a 50.8 cm long Leak Detector Cable (LDC) as described in the Materials Table above.

### Test Methods:

### Detector Response Test

An electrical circuit, as shown in FIG. 7A, was built using six R₁ resistances in series giving a total resistance of 280.1 kΩ as measured by the DMM. The conductors of the sensors were connected to the electrical circuit. With different voltage signals applied as the reference signal, the Oscilloscope was used to monitor the reference source voltage and signal voltage (voltage drop) without and with tap water dispensed on the leak detector film or Leak Detector Cable. In the case of the leak detector film, water was dispensed closed to the end of the leak detector film, on the water permeable substrate side of the leak detector film, just enough to touch both conducting elements of the leak detector film. In the case of the Leak Detector Cable, water was dispensed close to the end of the cable laid on a laboratory bench until a measurable response was detected. Four different signals were separately tested with the leak detector film, while the LDC was tested only with DC signal as described below:

1—Sinusoidal AC Signal:

A sinusoidal AC voltage nominally at ±5V peak-to-peak and 100 Hz generated from the Waveform Generator was applied as a reference source voltage.

2—Square Wave AC Signal: A square wave AC voltage nominally at ±5V peak-to-peak and 100 Hz generated from the Waveform Generator was applied as a reference source voltage.

3—AC Signal Pulses:

Alternating square pulses at 100 Hz with 50% duty cycles and nominally +5V amplitude generated from the Waveform Generator was applied as a reference source voltage.

4—DC Signal:

A nominally +5V DC amplitude generated from the Power Supply was applied as a reference source voltage.

### Electronic Control Trigger Test:

A leak detector film was connected to a Leak Detector Device as shown in FIG. 10. A Server Cooling Fan with two fans 940 was also connected to the Leak Detector Device. Fan 1 was connected between 120V AC signal source 945 and “normally closed” port of the Output Connector 930 and Fan 2 was connected between AC signal source 945 and “normally open” port of the Output Connector 930. Two 200V input terminals 920 of the Leak Detector Device were connected to 120V AC supply 925 as shown in FIG. 10. In the absence of water on the leak detector film, the “Leak Indicator” light 955 on Leak Detector Device was OFF, the Leak Detector Device was not making any sound, Fan 1 that was connected “normally closed” port was ON and Fan 2 which was connected to “normally open” port was OFF. Water drop(s) were added to the detector and the resulting output changes were observed in the Leak Detector Device.

### Results:

Detector Response Test results for Example 1.

Table 1 shows the change in the voltage measured across the leak detector film (Example 1) with a ˜0.25 mil water droplet on the conductive elements. As soon as the water droplet was removed using a paper towel, the signal response came back to its original value prior to dispensing water on the leak detector film.

TABLE 1

| | | Dry Film | | Film With ~0.25 ml Water Droplet | |
|---|---|---|---|---|---|
| Response With | Measurement Across | Min (V) | Max (V) | Min (V) | Max (V) |
| Sinosoidal AC Signal | Applied Source Reference | −5.04 | 5.12 | −5.04 | 5.12 |
| | Conducting Elements | −4.96 | 4.96 | −0.16 | 0.24 |
| Square Wave AC Signal | Applied Source Reference | −5.04 | 5.12 | −5.04 | 5.12 |
| | Conducting Elements | −4.96 | 5.04 | 0 | 0.32 |
| AC Signal Pulses | Applied Source Reference | −0.08 | 5.12 | −0.08 | 5.04 |
| | Conducting Elements | −0.08 | 5.04 | 0.48 | 0.72 |
| DC Signal | Applied Source Reference | 4.96 | 5.12 | 4.96 | 5.12 |
| | Conducting Elements | 4.88 | 5.04 | 0.32 | 0.48 |

Detector Response Test results for Comparative Example 1.

Table 2 shows the change in the voltage measured across the LDC (Comparative Example 1) with water on the conductive elements using the DC signal test. Water droplets were slowly dispensed on the LDC until a response was detected. It was observed that the amount of water needed to induce a measurable change in the signal was significantly higher (˜5 ml) than that was needed to induce change in the Example 1 described above. Comparing these results with the results from Example 1 DC signal test, it was observed that the change was not as large as that was observed with a small water droplet with the leak detector film described above. Once the water droplet was dried using paper towel, the signal came back to its original value.

TABLE 2

| | | Dry LDC | | LDC With ~5 ml Water Droplet | |
|---|---|---|---|---|---|
| Response With | Measurement Across | Min (V) | Max (V) | Min (V) | Max (V) |
| DC Signal | Applied Source Reference | 4.96 | 5.12 | 4.96 | 5.12 |
| | Conducting Wires | 5.04 | 5.2 | 2 | 2.16 |

### Electronic Control Trigger Test Results for Example 1.

When a small (˜0.25 ml) droplet of water was dispensed onto the insulating substrate side of the leak detector film (Example 1), “Leak Indicator” light on Leak Detector Device turned ON, the Leak Detector Device started to make high pitch sound, Fan 1 turned OFF and Fan 2 turned ON. As soon as the water droplet was dried from the sensor surface, audio-visual response from the Leak Detector Device and the server fans reverted to their respective original states. This indicates, with proper electronics, the leak sensor can be used to trigger audio-visual response from a leak. Moreover, the sensor can detect the leak and with proper electronics can trigger different controls (for example, turning water pump OFF, turning heater ON, turning a fan ON).

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A film, comprising:
two spaced-apart, substantially coplanar conducting elements, such that when the film is disposed adjacent a liquid-carrying conduit, and there is a leaked liquid released from the conduit, the film transmits at least a portion of the leaked liquid to an internal region of the film, the portion of the leaked liquid changing a characteristic of the elements detectable by a circuitry coupled to the conducting elements.

2. The film of claim 1, wherein the film does not transmit the leaked liquid therethrough.

3. The film of claim 1, wherein the leaked liquid is a conducting liquid and the characteristic of the conducting elements is an amount of resistance between the conducting elements.

4. The film of claim 1, wherein the leaked liquid is a dielectric liquid and the characteristic of the conducting elements is an amount of capacitance between the conducting elements.

5. The film of claim 1, wherein the film is helically wrapped around at least a portion of the liquid-carrying conduit.

6. The film of claim 1, wherein the film is longitudinally wrapped around at least a portion of the liquid-carrying conduit.

7. The film of claim 1, wherein the film is applied to a surface of the liquid-carrying conduit.

8. The film of claim 1, wherein the film is applied on an inside surface of an external jacket covering the liquid-carrying conduit.

9. The film of claim 1, further comprising circuitry coupled to the conducting elements for detecting the changing characteristic of the conducting elements.

10. The film of claim 9, wherein the circuitry coupled to the conducting elements initiates a response upon detecting the changing characteristic of the conducting elements.

11. The film of claim 10, wherein the response comprises one or more of sounding an alarm, displaying a visual indication, terminating a flow of liquid through the conduit, energizing a relay, and turning on a back-up system.

12. A leak detection film, comprising:
a liquid-permeable substrate;
a liquid-impermeable support substrate; and
two spaced apart substantially coplanar conducting films disposed between the liquid-permeable substrate and the support substrate;
wherein the liquid-permeable substrate, the support substrate, and the conducting films are substantially co-extensive in length, and configured such that when the leak detection film is disposed adjacent a liquid carrying conduit, and there is a leaked liquid released from the conduit, the leak detection film transmits at least a portion of the leaked liquid to an internal region of the leak detection film, the portion of the leaked liquid changing a characteristic of the conducting films detectable by a circuitry coupled to the conducting films.

13. The leak detection film of claim 12, further comprising a connector attached to an end of each of the conducting films.

14. The leak detection film of claim 13, further comprising circuitry coupled to the connector for detecting the changing characteristic of the conducting films.

15-16. (canceled)

17. The leak detection film of claim 12, further comprising a liquid-absorbing material.

18. A liquid circulating system, comprising:
a liquid-carrying conduit; and
a leak sensor extending along a length of the conduit, comprising
a liquid-permeable substrate facing and adjacent to the conduit;
a support substrate;
two spaced-apart substantially coplanar conductors disposed between the liquid-permeable substrate and the support substrate; and
circuitry coupled to the conductors for detecting a change in electrical properties between the conductors in a presence of a leaked liquid from the liquid-carrying conduit.

19. The liquid circulating system of claim 18, wherein the leaked liquid is a conducting liquid and the change in electrical properties is a change in resistance between the conductors.

20. The liquid circulating system of claim 18, wherein the leaked liquid is a dielectric liquid and the change in electrical properties is a change in capacitance between the conductors.

21. The liquid circulating system of claim 18, wherein the support substrate is liquid-impermeable.

22. The liquid circulating system of claim 18, wherein the leak sensor is wrapped around the at least a portion of the liquid-carrying conduit such that the support substrate forms an outer barrier substantially containing the leaked liquid.

23. (canceled)
